(19) United States
(12) Patent Application Publication
(10) Pub. No.: US 2002/0055891 A1
(43) Pub. Date: May 9, 2002

(54) Researching method and researching system for interests in commercial goods by using electronic catalog including interactive 3D image data

(76) Inventor: Yun-Won Yang, Seoul (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/927,938

(22) Filed: Aug. 13, 2001

(30) Foreign Application Priority Data
Aug. 16, 2000 (KR) 2000-47125

(51) Int. Cl. G06F 17/60

(52) U.S. Cl. 705/27

(57) ABSTRACT

A researching method and researching system for interests in commercial goods by using electronic catalogue including interactive 3D image data, whereby an electronic catalog including 3D display images are prepared for providing of same via internet web sites or e-mails and view record of client (control signal from client) is observed relative to particular 3D display image of a viewer who has viewed related electronic catalogue, and as a result of analysis on observational result, comparative research is performed on client reactions against respective publicized commercial goods and preference of clients, wherein a identification code is provided to groups of images for being alternatively displayed to produce a 3D display effect, thereby allowing the viewer to directly control an alternative display effect and to view the groups of images for recording on a storage apparatus at server side; a control tag is added for a client to directly control display effect for the groups of images and preparing electronic catalogue documents so that the groups of images having controllable display effect can be insertedly displayed; the prepared electronic catalogue documents provided at a state where client can view same; a display control signal is collected, classified and recorded when the client views the electronic catalogue documents and transmits a display control signal for controlling the display effect against 3D display images which are groups of images for being insertedly displayed at the electronic catalogue document to create the 3D display effect; and preference against goods displayed on related 3D display image is analytically evaluated based on record relative to display control signal from client who has viewed the catalog documents.

### FIELD OF THE INVENTION

The present invention relates to a researching method and a researching system for interests in commercial goods by using electronic catalog including interactive 3D image data adapted to use an electronic catalog where interactive three dimensional (3D) display image is insertedly displayed, thereby enabling to research customer preference to publicized goods.

### DESCRIPTION OF THE PRIOR ART

The present invention relates to a researching method and a researching system for interests in commercial goods by using electronic catalog including interactive 3D image data adapted to use electronic catalog provided via data communication networks such as Internet and the like, thereby enabling to comparatively detect customer preference in each commercial goods.

Particularly, the present invention uses a technology of inserting and displaying on a catalog a three dimensional effect image (hereinafter simply referred to as 3D display image) created when individual images comprising groups of images are continuously and alternatively displayed on one image display window.

Again, the present invention relates to a method and an apparatus for comparative research of interests in commercial goods, where the aforementioned technique is utilized by which a catalog is prepared that contains a 3D image of commercial goods and introduction to related goods to be laid open for customers to view (or to read), while related customers review and record control contents for controlling display effect of goods images when the relevant customers view the catalog for analysis of the viewed result, thereby enabling to comparatively research a preference to the goods.

A variety of 3D image display techniques have been recently utilized for Internet image display technique. By way of technique thereof, a 3D image display technique is disclosed where a multiplicity of individual image documents are grouped to form groups of images documents, whereby the groups of images documents are made to be sequentially and alternatively displayed on one display window, thereby generating a 3D image effect.

Another technique of providing similar effects is disclosed where a multiplicity of segmental images photographed in the same space are mosaically combined to form large panoramic images, and part of the panoramic images comprising segmental images in response to user control are made to be sequentially displayed on one window to generate a 3D spatial effect.

According to the above-mentioned techniques, when a certain particular article or camera is first rotated for sequential photographs to obtain a plurality of image documents, and these documents are bound in groups of images documents which is designated in sequentially and alternatively displayed order, a viewer can obtain a 3D feeling of just like meticulously moving and viewing objects up, down, left and right on one screen when the viewer views 3D display images (3D object).

Moreover, when a camera is rotated in a particular space to perform a plurality of photographing for obtainment of a multiplicity of segmental images where the segmental images are mosaically combined to constitute a large scale of panoramic image for providing an effect of just like one continued image and the plurality of segmental images are continuously moved and displayed on one screen, a viewer can obtain a 3D feeling as if the viewer looks around within a 3D photographing space (3D panorama).

These image display techniques are combined with a technique where a viewer assists to the effect that a display effect of 3D display images is directly controlled. The display control effect is realized by providing a control tag along with 3D display images for a viewer to directly control display effects such as display sequence and the like against the groups of images.

Then, the viewer can control the display effect of images in a group by way of interactive (rotary direction control for display, enlarged display control of specific part) thereby enabling to obtain a 3D interactive display image effect.

There are technical meanings distinctive from moving pictures in that even relatively small capacity can obtain an effect similar to 3D moving picture in preference to a large capacity of moving picture, a user can control display effect by way of interactive unlike a unidirectional moving picture data and immediate ascertainment is possible at web browser with no speed drag and without separate plugs.

There techniques are therefore effectively used in providing a turn-around effect to large sized clothing and sculpture where customers' 3D observation requests are huge providing a viewing effect of use state to multi functional furniture and specially devised articles where use method ascertainment requests are big, providing an opening effect to such merchandises as refrigerators and the like where interior observation requests are large and providing a look-around effect at Internet shopping malls where a camera is located and rotated at a center of a particular space to photograph interiors of a building and surrounding landscape and to display same in panoramic view. In order to ascertain a further detailed display screen control contents, a sample disclosed on a Web Site (www.humandream.com) serviced by the present applicant may be referred to.

Furthermore, a protocol has been recently developed where a 3D display image for demonstrating the above-mentioned effects is contained on a catalog for provision to specific customers in publicity or advertisement material.

When a plurality of 3D display images are listed in a catalog made by the above-mentioned techniques and sent to customers, the customers can view the multiplicity of 3D display images displayed on the received catalog, where the customers may select the provided 3D display images and view same in look-around way or enlarge same at a particular portion. Moreover further detailed information may be obtained via a link listed in part of the images.

At this time, a control behavior for controlling a display effect by a viewer of a particular 3D display image is completed by a data communication between a remotely connected server and a viewer via communication networks such as Internet and the like. A server system is provided with respective groups of images comprising related 3D display images in respective resolutions for each part and portion.

To be more specific, the server system, as illustrated in FIGS. 9A to 9B, is recorded with groups of images (a first group of images has respectively, by way of example, 128×256 pixels) comprising respective images.

The respective groups of images are respectively created in such way that resolution of a group of images is lowered from another group of images (a second group of images has respectively, by way of example, 256×512 pixels) which is higher in resolution than the respective images of a group, and another group of images (the second group of images) is created in such way that resolution of another group of images is reduced from still another group of images (a third group of images has respectively, by way of example, 512×1024 pixels).

Furthermore, at least in the second group of images and the third group of images, the images are divided into a plurality of segmental images to which respective coordinates are designated and coupled in mosaic shapes for storage. By way of example, the images of second group may be respectively comprised of four 128×256 pixels while the images of third group may be respectively composed of sixteen 128×256 pixels. Of course, the images of first group may be also respectively formed with mosaic couplings of a multiplicity of segmental images.

When an enlarged image comprising of segmental images thus described is prepared and when a viewer designates a specific position to request an enlarged image displayed as shown in FIG. 10, the enlarged image necessary for constitution of FIG. 10 is provided from server to client side, whereby screen is displayed according to size of display window.

There is an advantage in the structure thus described in that even if a viewer repeatedly requests a moved display of screen while the enlarged image is being viewed, image cache function can be used such that unnecessary communications may be deleted where image transmission needed for constitution of display screen is requested every time from a server and image is received for display.

The advantage thus described has a meaning in that resources can be saved, response speed can be increased and processing quantity of servers can be reduced.

Disclosed technique related to display of 3D display images and image expansion include Internet Imaging Protocol (IIP) designed by Hewlett Packard Company, Live Picture, Inc., and Eastman Kodak Company, or a way using “image server” structured to utilize FlashPix Format. The way mentioned above adopts a way where a plurality of images per resolution are stored on “image server”, and domain necessary for enlarged image display is operated in response to client request to create an image of related domain and to transmit same to client side.

In this case, there is a disadvantage in that respective plural images recorded per resolution are partitioned into a plurality of tiles, and in order to dynamically cope with enlarged position change request from client, a high powered “image server” is needed, thereby resulting in unnecessary consumption of resources.

U.S. Pat. No. 6,148,333, disclosed after a Korean Patent Application No. 10-2000-0047125 which is a priority of the present application, discloses a server approach control, tracking method and system thereof utilizing the aforementioned image server.

The disclosed protocol basically assumes on “image server” based on IIP, such that a method is used where entire enlarged image is partitioned into random same size of 64×64 pixels while access against designated tiles is monitored.

As a result, it can be said that the approach method is quite different from the technique disclosed by the present applicant where an enlarged image comprising mosaic combination of segmental images is used to provide a 3D display image. According to the difference of the approach method therebetween, there occurs a stark difference in terms of response speed in providing enlarged images, reliability of network resources and efficiency of server structure.

According to the protocol of providing a 3D display effect in the structure thus described, client clicks a control button mounted at an image display window to thereby transmit to a server system a display direction control signal, a display speed control signal, requested enlarged display control signal and requested link call control signal when a catalogue so structured as to insertedly display a 3D display image is provided to the client.

Then, the server receives these signals to provide a specific particular data necessary for completion of screen display indicated by a use out of individual image data according to the requested control signal, such that server system can receive in a remote state a requested display direction change, a requested display speed change and requested enlarged display against part of 3D display images from a viewer, or control signal for connecting link listed in part of 3D display images, thereby enabling the server to detect all control signals of client.

### SUMMARY OF THE INVENTION

The present invention utilizes the afore-mentioned 3D image display technique, and it is an object of the present invention to provide a researching method and researching system for interests in commercial goods by using electronic catalogue including interactive 3D image data, whereby electronic catalogs including 3D display images are prepared for supply of same to Internet web sites or e-mails and viewed record (control signal from client) is observed relative to particular 3D display image of a viewer who has viewed relevant electronic catalogue, and as a result of analysis of observation result, comparative research is performed on client reactions against respective publicized commercial goods and preference of clients.

In accordance with one object of the present invention, there is provided a researching method for interests in commercial goods by using electronic catalogue including interactive 3D image data, the method comprising the steps of:

recording groups of images creating a 3d display effect when it is provided to a client on a server, wherein each group of images having a multi-layered resolution, and the images each being constructed of a multiplicity of segmental images;

preparing electronic catalogue documents containing a display information relative to several groups of images to be provided with a lowest resolutions on initially being displayed, and display effect control tags against the groups of images such that an image insertedly displayed as part of contents of catalogue documents to raise a 3D display effect while the 3D display effect can be controlled by the client when the client having been accessed at a remote state can view the catalogue document;

providing a state where the prepared electronic catalogue document can be view by the client;

collecting, classifying and recording a display control signal when the client views the electronic catalogue documents and transmits the display control signal for controlling display effect against the groups of images for being insertedly displayed on the electronic catalogue documents and producing enlargement/reduction display effect; and

analytically evaluating observational behaviors relative to goods image displayed on related display screen, on the basis of records of the display control signal from the client who has viewed the electronic catalog documents.

In accordance with another object of the present invention, there is provided a researching system for interests in commercial goods by using electronic catalogue including interactive 3D image data, the system comprising:

means for recording groups of images on a server, wherein each group of images having a multi-layered resolution and creating a 3d display effect when it is provided to a client, and the images each being constructed of a multiplicity of segmental images;

means for preparing electronic catalogue documents containing a display information relative to several groups of images to be provided with a lowest resolutions on initially being displayed, and display effect control tags against the groups of images such that an image insertedly displayed as part of contents of catalogue documents to raise a 3D display effect while the 3D display effect can be controlled by the client when the client having been accessed at a remote state can read the catalogue document;

means for providing a state where the prepared electronic catalogue document can be read by the client;

means for collecting, classifying and recording a display control signal when the client reads the electronic catalogue documents and transmits the display control signal for controlling display effect against the groups of images for being insertedly displayed on the electronic catalogue documents and producing enlargement/reduction display effect; and

means for analytically evaluating observational behaviors relative to goods image displayed on related display screen, on the basis of records of the display control signal from the client who has read the electronic catalog documents.

By providing the present invention thus described, when an electronic catalogue including 3D display images and introductions for several commercial goods are provided to clients, observational status of clients for respective 3D display images can be easily ascertained. As a result, comparative analysis of preference relative to each commercial goods can be implemented, and preference to particular portion of each commercial goods can be researched as well. Therefore, there is an advantage in that the comparative analysis is performed before production of goods or before marketing of goods, whereby order quantity or production quantity can be controlled according to preference or interest to related products as well as according to advertisement of each goods.

And, client's, opinion can be simply analyzed, such as, by way of example, which particular portion of a commercial goods being specifically interested in by certain clients who have viewed images (enlarged portion is usually more interested in by clients.) or which particular portion of a commercial goods being paid attention to by the clients.

Particularly, by providing the afore-mentioned structure, an “image server” having disadvantages of using the prior IIP may be sidelined and other problems such as delay of response speed with all the advantages of high resolutions, dependency of network speed, high performance of server and the like can be also eliminated to thereby enable to provide a researching method and researching system for interests in commercial goods of faster response result and higher performance.

In accordance with a preferred embodiment of the present invention, in the aforementioned goods preference analysis method, images of high resolution, except for at least an image of the lowest resolution among a group of images, are comprised of a multiplicity of segmental images, where a display screen viewed by the clients is integrally displayed with the multiplicity of mosaically combined segmental images.

In accordance with a preferred embodiment of the present invention, in the aforementioned goods preference analysis method, the step of evaluating further comprises the step of analyzing related display image and frequency and observation period for observing a particular domain or a particular position of display image, based on the display control signal sent from the server.

As a result, catalogue inserted with a plurality of interactive 3D display images can be provided to clients, and an image selected by a client out of the plurality of interactive 3D display images can be found, and period and frequency for observing particular domain or particular position can be recorded to thereby enable to evaluate an interest close to an actual preference such as clients' interest and reaction thereof relative to a multiplicity of commercial goods (or new products).

Moreover, in accordance with a preferred embodiment of the present invention, the step of preparing the electronic catalogue documents further comprises the step of preparing electronic catalogue documents for comprising at least one link data for indicating a connection between part of screen displaying the interactive 3D image and other documents, whereas the evaluating step further comprises the step of clicking a specific part of related display image to analyze frequency of calling other documents connected to the part thereof.

By utilizing the afore-mentioned structure, preference to each of the multiplicity of goods displayed on an interactive 3D display image can be directly evaluated when an electronic catalogue is so prepared as to display a multiplicity of goods on an interactive 3D display image.

Furthermore, in accordance with a preferred embodiment of the present invention, wherein the step of providing the electronic catalogue documents on a state where a client can read same further comprises the step of transmitting the electronic catalogue documents to clients via electronic mail.

By adopting the structure thus described, the electronic catalogues can be transmitted to clients via electronic mail, whereby information about goods can be provided as a service by visiting, not as a service by being waited, and clients' preference can be easily analyzed by remote control.

Moreover, in accordance with a preferred embodiment of the present invention, the step of transmitting the electronic catalog documents to clients via electronic mail further comprises the step of mechanically inputting predetermined electronic mail address for classifying return mails and reply mails on a sender address list.

By adopting the afore-mentioned structure, often-occurring return mails are made to be returned by a return mail disposer while reply mails are made for return to persons in charge of specific merchandise to send replies when electronic catalogue documents provided through electronic mails are sent en masse.

Furthermore, in accordance with a preferred embodiment of the present invention, in the electronic catalogue documents transmitted via electronic mail, when a client closes a text of electronic mail, a view termination notifying tag is made to be added for providing to server system a view termination signal for indicating an electronic mail view termination.

By adopting the afore-said structure, an entire viewing time (or reading time) of catalogue by a viewer can be checked, by which an effect relative to marketing techniques can be directly reviewed through the electronic mail while various marketing strategies can be accurately established in consideration of client reaction.

At this time, the recoding step records a transmission start time relative to groups of images to be insertedly displayed on the electronic catalogue and a time the view termination signal is transmitted by the view termination notifying tag, while the analyzing step analyzes an entire view time of electronic catalogue based on a time the view termination notifying tag is transmitted from the time the groups of images is transmitted.

Furthermore, the present invention comprises the step of notifying to a client administrator a fact that a particular client has started a specific display image when a client views the electronic catalogue documents, and transmission relative to groups of images to be insertedly displayed onto the electronic catalogue documents is made from server to the client. The present invention further comprises the step of automatically notifying to a client a message priorly set up relative to related image following receipt of a fact that the view has been started.

By way of the above-mentioned methods, a user can check a view statistic relative to the catalog up to the present time, and based on the statistic, a priorly-prepared introduction letter in relation to relevant goods is automatically sent to pre-allowed clients, or real-time chatting, communication, introduction letter dispatch can be attempted by prepared consultants, such that a variety of marketing techniques can be utilized.

Furthermore, a preferred embodiment of the present invention further comprises the step where, when a client closes a text of electronic catalogue documents, a view termination notifying tag is added for providing a view termination signal for indicating the catalogue view termination, and when a view termination signal for indicating catalog view termination is provided, a particular client provides to the client administrator a fact that a view of a particular display image has been terminated, along with an analytic evaluation result of observational behavior against goods image displayed on related display image.

By adopting the structure thus described, a variety of client relation control programs such as request of client consultation adequate to client reaction already analyzed relative to a client can be performed as soon as view of image by a client is completed.

Particularly, in case electronic catalog documents are provided, and when view start time and view termination time are made to be notified to a person or a client administrator who is concurrently an automatic process device, a variety of client relations control and services related thereto can be implemented at a moment views are performed between the two times and at a time the view is ended.

### BRIEF DESCRIPTION OF THE DRAWINGS

Other objects and aspects of the invention will become apparent from the following description of the embodiments with reference to the accompanying drawings, in which:

FIG. 1 is a schematic drawing of network system for providing to clients electronic catalogues including interactive 3D display image;

FIG. 2 is a detailed drawing of a server system where a research analysis system for client interest on publicized goods is installed according to the present invention;

FIG. 3 is a process flow chart for illustrating a process sequence for analyzing an client interest relative to publicized goods utilizing electronic catalogues where interactive 3D display images are insertedly displayed according to the present invention;

FIG. 4 illustrates a screen which has captured a state where a viewer ascertains via electronic mail the electronic catalogue prepared to allow a 3D display image relative to publicized goods to be insertedly displayed according to the present invention;

FIG. 5 illustrates a screen which has captured a state where a viewer ascertains a 3D display image as a result of having sent a control signal for enlargingly displaying part of 3D display image illustrated in FIG. 4;

FIGS. 6A to 6D illustrate examples of panoramic 3D display images for depicting 3D spatial effect by being inserted into the electronic catalogue;

FIG. 7 illustrates a state where part of FIG. 6d is being enlarged and ascertained;

FIG. 8 illustrates a screen which has captured a state where a viewer clicks a link in FIG. 7 to view another 3D display image in relation to related goods;

FIGS. 9A to 9B each illustrate a screen which has captured a state where a 3D display image displayed at an uppermost window of FIG. 8 is rotatatively viewed, and each screen is a display screen related to each image of a group displayed when a viewer controllably observes the rotating direction, rotating speed and the like; and

FIG. 10 illustrates a screen which has captured a state where a viewer so instructs as to enlargingly display part of screen in FIG. 9 and to ascertain the enlarged image mosaically structured in a plurality of segmental images, each having a higher resolution than that of FIG. 9.

### DETAILED DESCRIPTION OF THE INVENTION

Now, a preferred embodiment of the present invention will be described in detail with reference to the accompanying drawings.

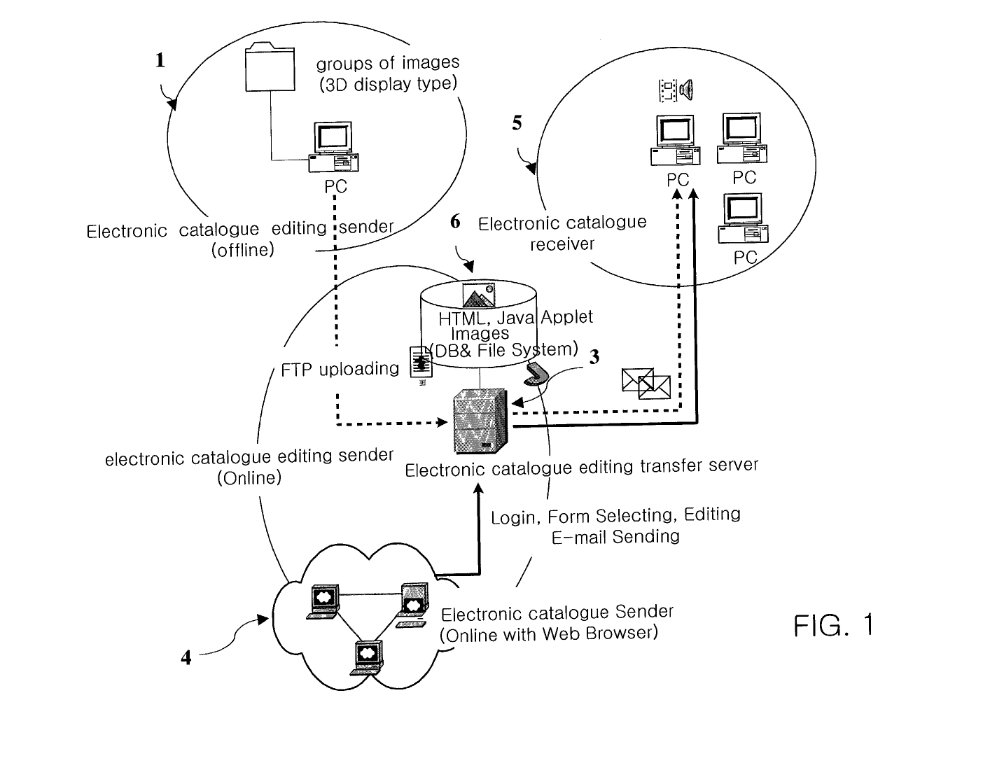

FIG. 1 is a schematic drawing of a network system for providing to clients electronic catalogues including interaction 3D display image.

As illustrated in the drawing, electronic catalogues to be provided to clients are prepared off-line utilizing an exclusive electronic catalogue editing sender 1 for transmission to a server 3 via Intranet, FTP access or the like, or are prepared real time by an operator accessed to Internet via http web browser to be sent to the server 3.

Alternatively, the electronic catalogues may be prepared using an exclusive electronic catalogue editing sender included in on-line electronic catalogue editing transfer server 3.

The prepared electronic catalogues are generally recorded at a recording apparatus 6 which is under administration of the server 3 and delivered to a client who is an electronic catalogue receiver 5 according to transmittal request by senders 1 and 4.

At this time, image data of a group for structuring 3D display images to be insertedly displayed at electronic catalogue document generally prepared in Markup Language such as HTML, XML, SGML is stored in the recording apparatus 6.

Furthermore, the electronic documents are recorded with information relative to stored position at the recording apparatus 6 where 3D display image files (image data of a group) to be displayed as part of documents, and a control tag (by way of example, Java applet or ActiveX can be used) for allowing an 3D image to be displayed as part of document and for allowing clients to directly control display format is also recorded.

As a result, the control tag is operated when a client who has received the electronic catalogue views the electronic catalogue to transmit a signal for requesting a transmission against the groups of image data to server system side so that 3D display image insertedly to be displayed on the electronic catalogue can be constructed and displayed.

The server system 3 responds to the request signal to send to client terminal image data of a group necessary for construction of related 3D display images.

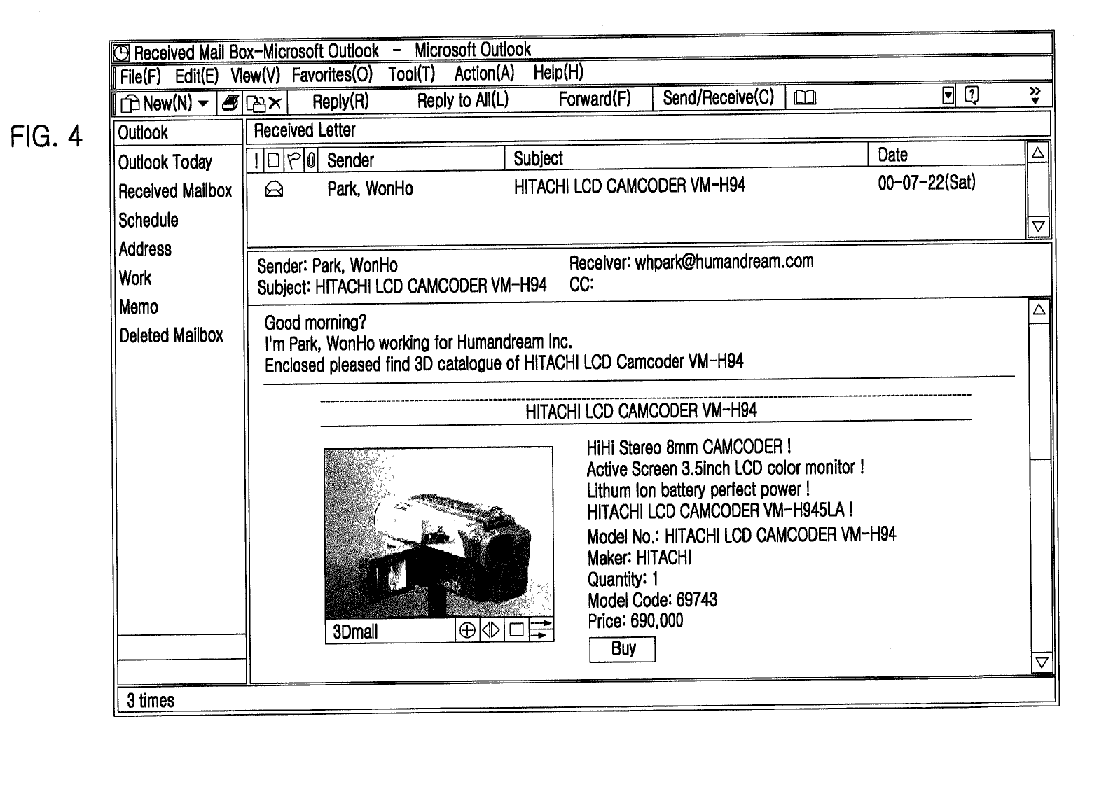

FIG. 4 illustrates a screen which has captured a state where a viewer ascertains via electronic mail an electronic catalogue prepared to allow a 3D display image relative to publicized goods to be insertedly displayed according to the present invention.

The electronic catalogue documents as illustrated in FIG. 4 are so prepared as to add a detailed description of goods publicized via at least one two dimensional (2D) enlarged controllable display image or 3D display image or on said two images.

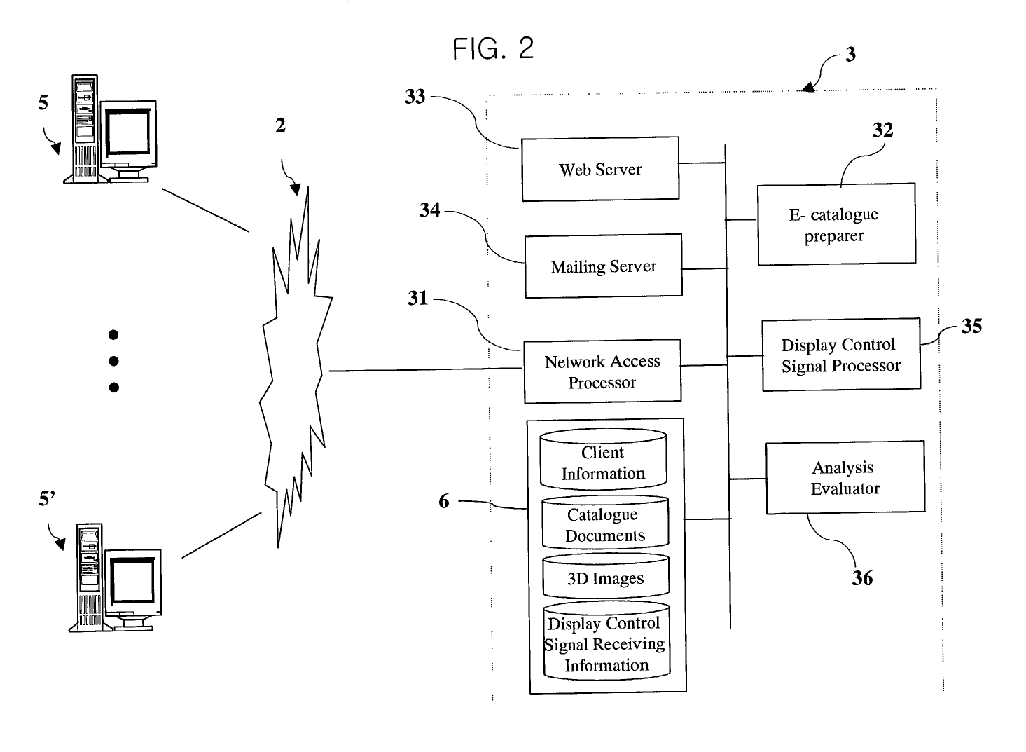

FIG. 2 is a detailed drawing of a server system where a research analysis system for client interest on publicized goods is installed according to the present invention.

The research analysis system in FIG. 2 includes a network access processor 31, an electronic catalogue preparer 32, a web server 33 used as electronic catalogue providing means, a mail server 34, display control signal processing means 35 and analysis evaluation means 36. The server system 3 further includes a recording apparatus 6 for storing clients' information, a multiplicity of electronic catalogue documents, a multiplicity of image data of a group comprising plural 3D display images insertedly displayed on the electronic catalogue documents and information receipt about display control signal.

In these construction, the network access processor 31 serves to provide on-line electronic catalogues to a plurality of clients 5 and 5′ and control the data changes and transmission and receipt in order to respond to control signal of clients.

Furthermore, the web server 33 provides web documents so constructed as to include electronic catalogues to clients 5 and 5′ who have accessed via web site while mail server 34 sends the electronic catalogue documents to the designated clients 5 and 5′ according to sender's request.

The electronic catalogue preparer 32 provides priorly prepared catalogue documents to an editing sender accessed online or enables to real-time prepare the catalogue documents on-line and performs data processing for processing an edited content of the editing sender to prepare a completed catalogue document. Furthermore, the electronic catalogue preparer 32 may be so constructed as to be provided to a local computer accessible to server via networks.

The display control signal processing means 35 receives a control signal for processing requests to implement processes related to image data transmission appropriate to content of the requests when a client viewing the electronic catalogues requests an enlarged screen display for observing in more detail the 3D display image insertedly displayed on the electronic catalogue or clicks a link inserted to the 3D display image to request a call to other designated documents.

Furthermore, display control signal processing means 35 collects the information relative to clients who have requested transmission of control signal, identification code of electronic catalogue, the time the control signal was received, process request content requested through the control signal when the control signal is received from viewers, to record same on display control signal information receipt recording domain at the recording apparatus 6.

Analysis evaluation means 36 analyzes the received information of the display control signal recorded at the recording apparatus 6 by the control of the display control signal processing means 35 to evaluate interests against publicized goods displayed per client. At this time, principal elements of evaluation are statistical analysis relative to duration of observation to a 3D image out of plural 3D display images insertedly displayed on the electronic catalogues, whether a detailed observation to a certain 3D image has been a realized, whether a detailed observation to a certain part of 3D image has been implemented, or which link has been opened out of links listed on the 3D display images. The base of the statistical analysis may be ascertained by display control signal transmitted by a client who is also a viewer.

Data initially obtainable from the display control signal includes data on which segmental image was requested to be displayed out of plural segmental images comprising 3D display images, which position of 3D display image was designated for enlarged image and up to what level, how long a certain image was observed.

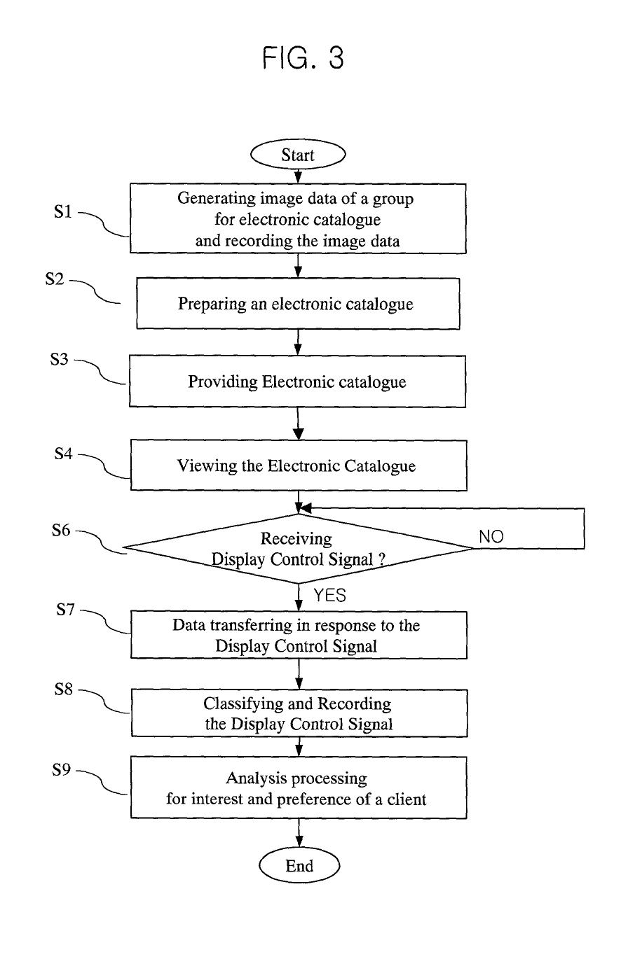

FIG. 3 is a process flow chart for illustrating a process sequence for analyzing a client interest relative to publicized goods utilizing electronic catalogues where interactive 3D display images are insertedly displayed according to the present invention.

As illustrated in FIG. 3, method of researching a client preference relative to publicized goods of the present invention first starts from generating image data of a group through digital panoramic photographing in order to construct a 3D display image insertedly displayed on the electronic catalogue and to store the generated data, step S1.

After completion of generation of the 3D display image, an editor prepares an electronic catalogue, step S2. Content regarding preparation of electronic catalogue may be referred to other applications filed by the present applicant.

Furthermore, when the electronic catalogue is completed in preparation, the prepared electronic catalogue is provided to the client via electronic mails or web pages, step S3, and is made to lie in state for clients to view, step S4.

At this time, in case the electronic catalogue is transmitted in the form of electronic mail, mail server 34 may be listed to make a send address different from return mail address of electronic catalogue or reply mail address. This is realized by automatic process where predetermined addresses are mechanically listed on the items of the send address when electronic mails are sent. By way of example, when electronic mails are transmitted en masse, Mail Form is listed at an address thereof with “automatic process-return mail code \mathring{a} mail server” while Reply To is listed with electronic mail address of a person who will take charge of customer control.

If constructed thus described, mass electronic mail dispatch is performed by send Mailer, and if there occur return mails (non delivery mails: NDR) due to discrepancy of client's electronic mail address, hitch of receiving mail server or the like, these return mails are received by return mail process program at designated return mail receiver, and designated post-process including amendment to mailing list is provided as performance data.

Meanwhile, when an electronic mail receiver views the send mails and replies thereto, reply electronic mail is directly transmitted to an electronic mail account of a person in charge per goods listed in Reply To, where the person in charge can perform an appropriate client control according to reply electronic mail.

As a means for implementing mechanical automatic process performed by send mail, a method utilizing SMTP protocol can be given as example. In this case, Mail Form item of send electronic mail may be listed with a form of address such as, by way of example, 3Dcat.NDR20011228230505@catmain.humandream.com, and Reply To item of send electronic mail may be listed with such form of address as jjkim@humandream.com which is an electronic mail address of a person in charge.

FIG. 4 illustrates a screen which has captured a state where a viewer ascertains via electronic mail the electronic catalogues prepared to allow a 3D display image relative to publicized goods to be insertedly displayed according to the present invention.

In the present invention, electronic catalogue document used for analyzing the client preference is insertedly displayed with 3D display effect images respectively made by images of a group comprising a plurality of segmental images, whereby, a client who has viewed catalogue document for publicity as shown in FIG. 4 may select a variety of display methods by dragging the images or by pressing a control button located at a lower right end of image display domain. In other words, a client who is also a viewer turns up, down, left, or right a related goods relative to preference to the related goods or opens same to thereby obtain a 3D display visual effect.

Particularly, in case various goods are provided a same classification, an observation time can be lengthened for a goods inducing client's interest more and behavioral observation can be further complicated. In other words, the client will so behave as to enlargingly observe a particular part or frequently view a particular screen.

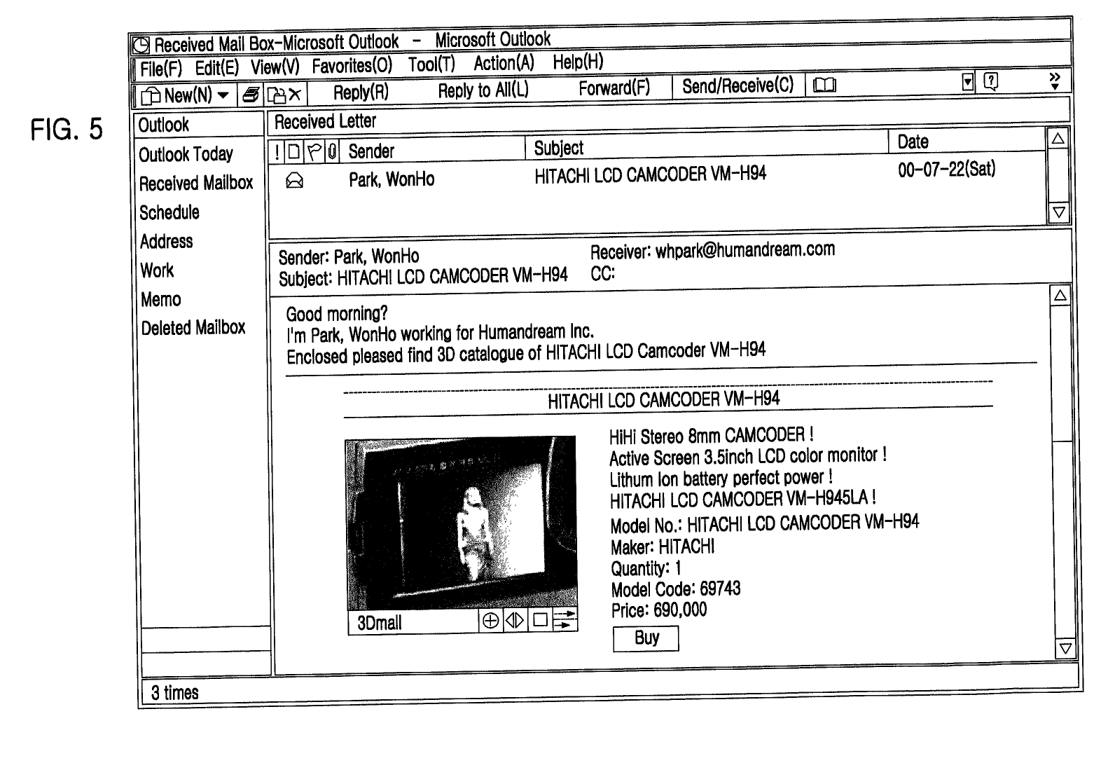

By way of example, when a viewer tries to view a display of a camcorder illustrated in FIG. 4 more closely, the viewer selects a screen enlarging icon (an extreme left icon at a lower end of screen) to designate a position desired for enlargement, thereby enabling to ascertain an enlarged screen as illustrated in FIG. 5. As mentioned above, the viewer just clicks the screen enlargement icon to be able to enlarge and ascertain a desired part.

Meanwhile, in a control for screen enlargement, although a viewer can ascertain an enlarged screen just by clicking an enlarged icon, screen enlargement display process is implemented by a complicated post-process relative to control program (by way of example, Java applet or ActiveX can be used) provided along with 3D display images.

To be more specific, when a client requests a screen enlargement display, the control program creates a display control signal related to an enlargement display control command of the client to transmit same to the server system 3 via network, requesting an enlarged image transmission relative to a designated domain, step S6. The server system 3 receives the control signal containing the screen enlargement request to transmit to the client a multiplicity of image data (segmental image data) for comprising designated enlarged images and performs a processing (step S7) responsive to the request.

The control signal process means 35 classifies the display control signal transmitted from the viewer to record same on a related domain of the recording apparatus 6 after afore-mentioned processing is completed for responding to the display control signal from a client to send segmental image data for comprising enlarged images for requesting additional transmission, step S8.

Furthermore, after a certain lapse of time, analysis process means 36 implements a process of analyzing the display control signal sent from the plurality of clients, step S9. At this time, principal subjects of analyses are which 3D display image of a goods out of plural 3D display images was given a close observation for a long time and which part of the 3D display image was given a close observation (duration of observation and up to what level of enlarged image was observed). When a result obtained therefrom is statistically analyzed, client reaction to the plurality of publicized goods insertedly displayed on the electronic catalogues, client interest and preference element may be analyzed.

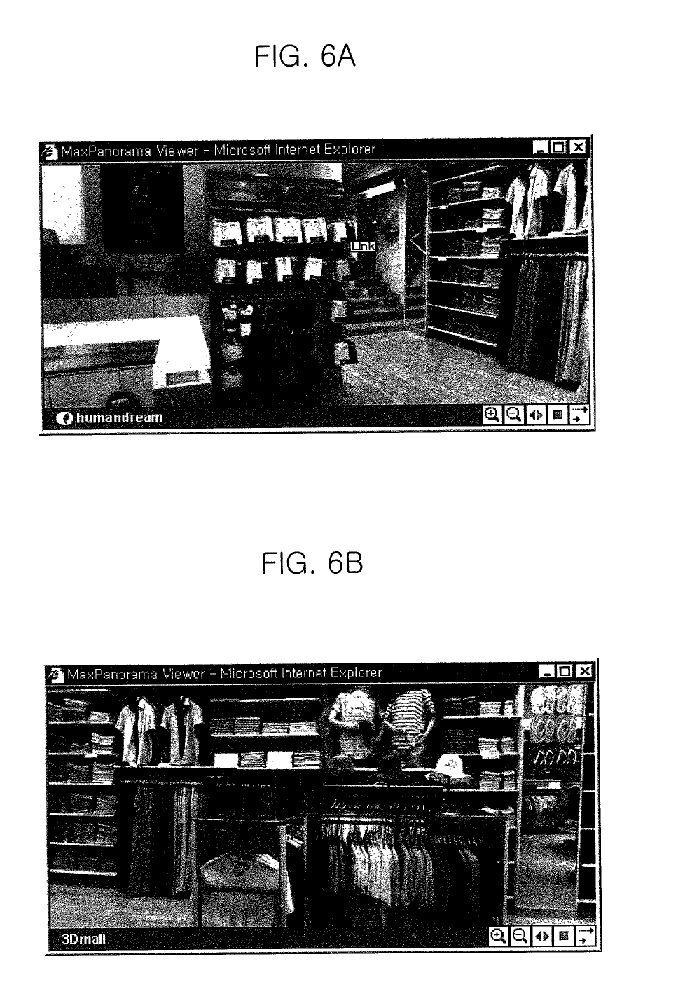

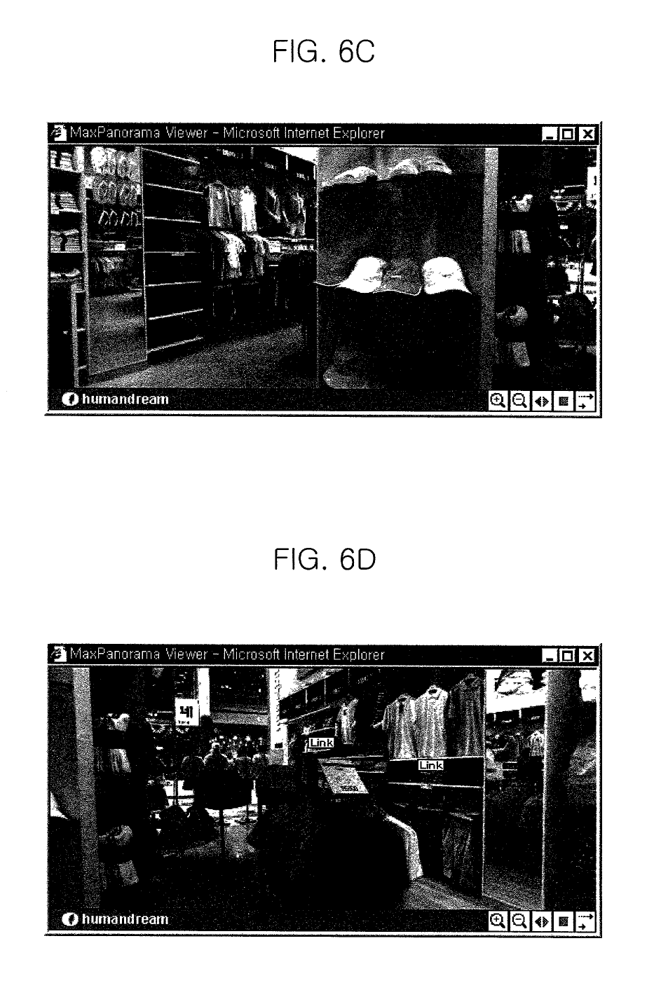

FIGS. 6A to 6D illustrate examples of panoramic 3D display images for depicting 3D spatial effect by being inserted into electronic catalogue.

A client who is a viewer views sequence screens represented in 4 display screens in the direction from FIG. 6A to FIG. 6D and obtains a visual 3D spatial effect just like turning and viewing from right to left in a 3D space of an apparel shop.

This effect is realized by sequential continuous display where segmental images are removed by one column at right end while segmental images are added by one column at left end according as a client sends a control command for controlling display direction of image files (plural segmental image files) of a group obtained from panoramic photographing. As a result, the client who is viewing images feels the effect of continuously viewing the images.

Meanwhile, on this screen, the client who is a viewer puts a mouse cursor on a display screen to drag to the right, or presses a display direction change button (triangle image) underneath right of display screen box, by which the client can obtain the effect of turning and viewing the apparel shop from left to right, which is an opposite direction from the previous.

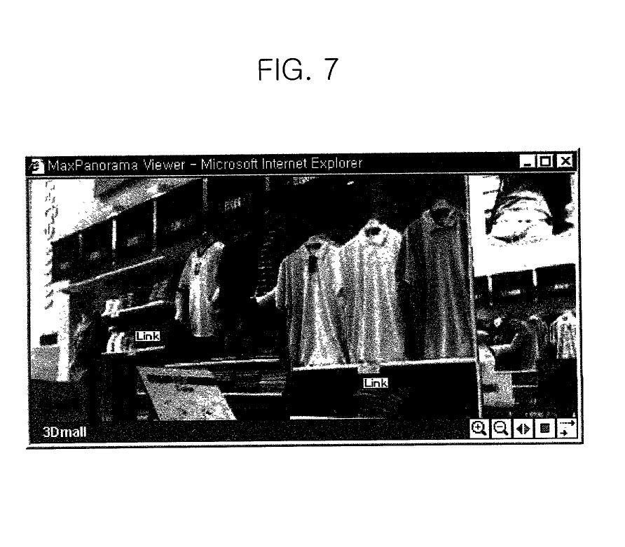

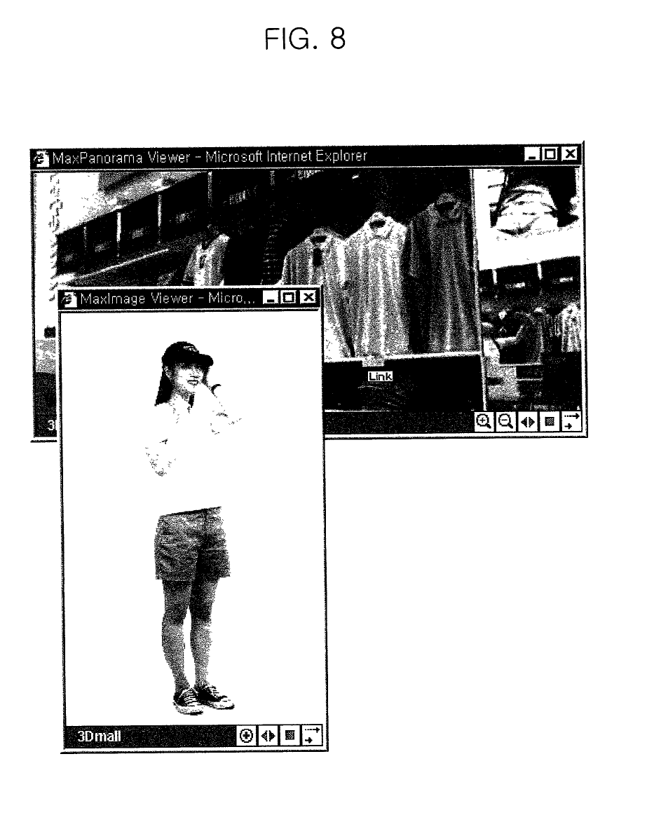

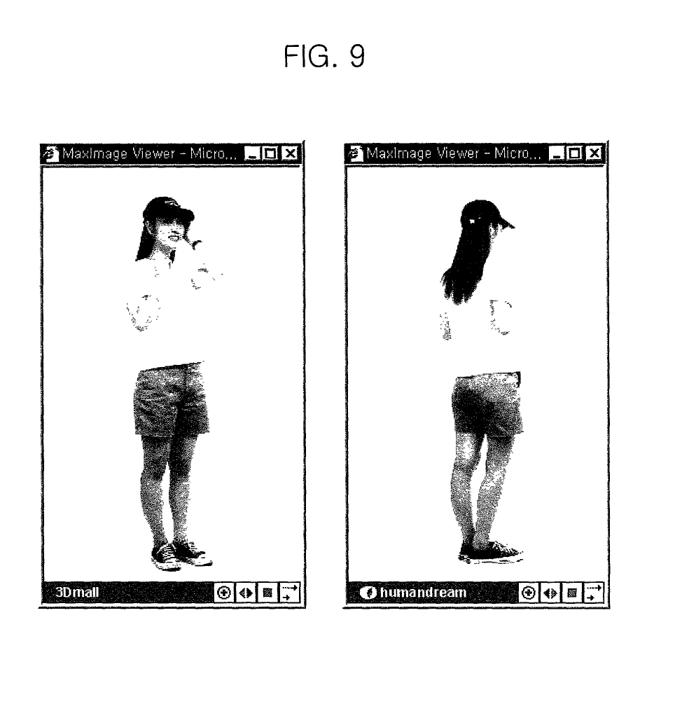

FIG. 7 illustrates a state where part of FIG. 6d is being enlarged and ascertained while a client is viewing FIG. 6D to designate a particular part and to request an enlarged display, and FIG. 8 illustrates a screen which has captured a state where a viewer clicks a link in FIG. 7 to view another 3D display image in relation to related goods by clicking Hyper link inserted into part of screen image of FIG. 7 (insertable into respective segmental images comprising an entire screen image), where an image displayed on uppermost window may be rotated and viewed as in FIG. 9 and part of screen in FIG. 9 may be designated to view an enlarged image relative to a particular part.

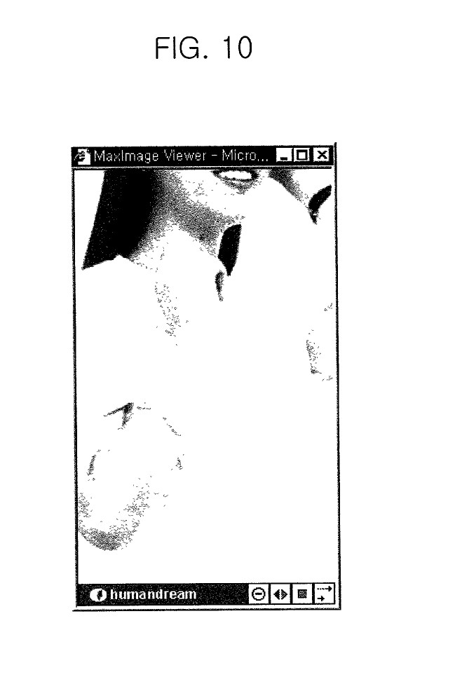

As illustrated in FIGS. 6 to 10, a process, where a client who has sent an electronic mail or viewed a catalogue disclosed on web site controls a display effect relative to 3D display image inserted into the catalogue, is observed by server system 3 from the beginning of viewing and is all recorded at the recording apparatus 6 at the server system 3 from a display effect control process thereof in the form of display control signal transmitted to the server system.

At this time, the display control signal includes a transmission request signal of additional image (enlarged image included) necessary for display of 3D display image, a call signal of other linked image and the like. Furthermore, analysis of the recorded display control signal by the analysis evaluation means 36 can indirectly ascertain an observation shape relative to client's image.

At this time, major statistic initially obtained through a certain operation from various display control signals which are fundamental data include which one and how many times was observed out of plurality of 3D display images inserted into the catalogue, which position of the image document was observed, an observation period spent for observing a particular 3D image, particularly which image was requested for enlarged image display, request frequency thereof, how far the enlarged level is, which link was called out of the multiplicity of links, and the like.

Utilizing these statistic as fundamental data, by way of example, client's reaction to new merchandises can be measured, and estimation as to which one attracts the highest client reaction out of various goods can be obtained, which can be used as an important data necessary for new merchandise planning.

Meanwhile, in the present invention, it is a general practice not to use “image server” constructed according to FlashPix format mentioned in the description of the prior art of the present specification. In this case, image cache function is utilized by client side, such that no more additional images are provided from the server system relative to segmental images already received from the server system but screen display is realized by utilizing images cached by client computer terminal.

Even at this time, a control tag added to the 3D display image transmits a display request of the client to server side for the server system to enable to ascertain observation behavior of the client.

Meanwhile, in the present invention, catalogue documents prepared in such languages as HTML, XML, SGML are added with special control tags for performing a function of a tracer. To be more specific, the control tags include a view start tracer for notifying a starting point of viewing and a view end tracer for advising an end point of viewing. An ordinary view start tracer may be a regular tag such as, by way of example, IMG SRC tag, while the view end tracer may be Applet tag, each being so constructed as to enable to ascertain a time of starting to view 3D display images and a time of closing the electronic mails. By using these, a client who is a viewer can evaluate the observing time of image very close to the reality.

Meanwhile, when a point for a customer to start to observe an image is grasped by the view start tracer, a variety of marketing techniques for customers may be utilized in various methods. By way of example, a message may be sent to a customer at an appropriate time (the point the customer takes time in observing a particular merchandise and is regarded as expressing interest thereto) by counting a view start time (the time a customer enters the shop) to request a chatting (which is similar to a situation where a shopper addresses to a customer in a shop), or special characters or voice messages may be transmitted, to arouse an interest to the customer on characteristics of goods.

In order to successfully implement the aforesaid techniques, it is preferable to notify a view start time of a customer to a marketer in the form of alarm or the like.

Furthermore, if some of observation conditions are met based on the view start time, a method may be also utilized to allow a special message to be sent. By way of example, if a view is started on a particular image, a certain designated time lapses and an observation up to a particular enlarged image against a certain image is implemented, a method of automatically sending messages including product guide priorly prepared in relation to related merchandise, product characteristics and the like via instant messenger may be utilized.

Moreover, at a time when the customer ends the viewing, an observation statistic of related customer and the like are collected to be relayed to the marketer as well, whereby each customer's observational behavior is ascertained after the customer's viewing is finished and a customer relation control appropriate to the behavior thereof can be processed.

By way of example, a detailed data on related merchandise may be sent to a visitor who has shown an interest of more than a certain level on a particular function of a particular merchandise, or reason why a final purchase has not been made on a related merchandise is grasped by communication means such as telephone conversation or the like and a customer relation control program appropriate thereto may be performed.

While, the preferred embodiment of the present invention has been described with regard to researching method and researching system for interests in commercial goods by using electronic catalogue including interactive 3D image data, it is not intended to limit the scope of the present invention. It will be understood by one of ordinary skill in the art that other variations and modifications are possible without departing from the spirit and scope of the novel concept of the invention.

By way of example, although the preferred embodiment of the present invention has principally described about a case where 3D display images are inserted, the instant invention can be directly applied without any correction to a case where a particular part of 2D image is enlargingly displayed. As a result, it should be apparent that the expression of “3D display image” used in the present specification is contained in the 3D display image described in the present specification, even in case only 2D image is provided and if the 2D image is comprised of combination of a plurality of segmental images, and if related enlarged images are included.

Furthermore, electronic catalogues may be produced in electronic catalogue documents prepared in Markup languages such as HTML, XML, SGML and the like contained in the text of electronic mail, and also produced in electronic catalogue documents prepared in Markup language affixed to electronic mail documents, and constructed in a form including Hyper Link relative to a particular web document.

Specifically, same is applied to a case where construction is made to insertedly display 3D display image through a separate new, browser window chiefly used in a web mail service system so measured as not to allow the 3D display image to be inserted into electronic mail text.

As apparent from the foregoing, there is an advantage in the researching method and researching system for interests in commercial goods by using electronic catalogue including interactive 3D image data, in that electronic catalogues including 2D or 3D display images are prepared to be provided to customers via Internet web sites or electronic mails, and view record relative to a particular 3D display image of a viewer who has viewed related electronic catalogue is observed and a result thereof is analyzed, thereby enabling to effectively implement a customer reaction with regard to respective publicized goods and comparative research against customer's preference.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A researching method for interests in commercial goods by using electronic catalogue including interactive 3D image data, the method comprising the steps of:
recording groups of images creating a 3d display effect when it is provided to a client on a server, wherein each group of images having a multi-layered resolution, and the images each being constructed of a multiplicity of segmental images;
preparing electronic catalogue documents containing a display information relative to several groups of images to be provided with a lowest resolutions on initially being displayed, and display effect control tags against the groups of images such that an image insertedly displayed as part of contents of catalogue documents to raise a 3D display effect while the 3D display effect can be controlled by the client when the client having been accessed at a remote state can view the catalogue document;
providing a state where the prepared electronic catalogue document can be view by the client;
collecting, classifying and recording a display control signal when the client views the electronic catalogue documents and transmits the display control signal for controlling display effect against the groups of images for being insertedly displayed on the electronic catalogue documents and producing enlargement/reduction display effect; and
analytically evaluating observational behaviors relative to goods image displayed on related display screen, on the basis of records of the display control signal from the client who has viewed the electronic catalog documents.

2. The method as defined in claim 1, wherein the step of evaluating further comprises the step of analyzing related display image and frequency and observation period for observing a particular domain or a particular position of display image, based on the display control signal sent from the server.

3. The method as defined in claim 1, wherein the step of preparing the electronic catalogue documents further comprises the step of preparing electronic catalogue documents for comprising at least one link data for indicating a connection between part of screen displaying the interactive 3D image and other documents, whereas the evaluating step further comprises the step of clicking a specific part of related display image to analyze frequency of calling other documents connected to the part thereof.

4. The method as defined in claim 2, wherein the step of preparing the electronic catalogue documents further comprises the step of preparing electronic catalogue documents for comprising at least one link data for indicating a connection between part of screen displaying the interactive 3D image and other documents, whereas the evaluating step further comprises the step of clicking a specific part of related 3D display image to analyze frequency of calling other documents connected to the part thereof.

5. The method as defined in claim 1, wherein the step of providing the electronic catalogue documents on a state where a client can read same further comprises the step of transmitting the electronic catalogue documents to clients via electronic mail.

6. The method as defined in claim 2, wherein the step of providing the electronic catalogue documents on a state where a client can read same further comprises the step of transmitting the electronic catalogue documents to clients via electronic mail.

7. The method as defined in claim 3, wherein the step of providing the electronic catalogue documents on a state where a client can read same further comprises the step of transmitting the electronic catalogue documents to clients via electronic mail.

8. The method as defined in claim 5, wherein the step of transmitting the electronic catalog documents to clients via electronic mail further comprises the step of mechanically inputting predetermined electronic mail address for classifying return mails and reply mails on a sender address list.

9. The method as defined in claim 6, wherein the step of transmitting the electronic catalog documents to clients via electronic mail further comprises the step of mechanically inputting predetermined electronic mail address for classifying return mails and reply mails on a sender address list.

10. The method as defined in claim 7, wherein the step of transmitting the electronic catalog documents to clients via electronic mail further comprises the step of mechanically inputting predetermined electronic mail address for classifying return mails and reply mails on a sender address list.

11. The method as defined in claim 8, wherein the electronic catalogue documents transmitted via electronic mail are added by a view termination notifying tag for providing to a server system a view termination signal for indicating an electronic mail view termination when a client closes a text of an electronic mail.

12. The method as defined in claim 9, wherein the electronic catalogue documents transmitted via electronic mail are added by a view termination notifying tag for providing to a server system a view termination signal for indicating an electronic mail view termination when a client closes a text of an electronic mail.

13. The method as defined in claim 10, wherein the electronic catalogue documents transmitted via electronic mail are added by a view termination notifying tag for providing to a server system a view termination signal for indicating an electronic mail view termination when a client closes a text of an electronic mail.

14. The method as defined in claim 1 further comprising the step of notifying to a client administrator a fact that a particular client has started a specific display image when a client views the electronic catalogue documents and transmission relative to groups of images to be insertedly displayed onto the electronic catalogue documents is started from the server to the client.

15. The method as defined in claim 14 further comprising the step of automatically notifying to a client a message priorly set up relative to related image following receipt of a fact that the view has been started.

16. The method as defined in claim 14 further comprising the step of adding to the electronic catalogue document a view termination notifying tag for providing to the server system a view termination signal for indicating catalogue view termination when the client closes the text of the electronic catalogue document, and the step of providing to the client administrator a fact that a particular client has terminated a view of particular display image along with an analytic evaluation result of observational behavior against goods image displayed on related display image when a view termination signal for indicating catalogue view termination is provided.

17. The method as defined in claim 1, further comprising the step of adding a view termination notifying tag to the electronic catalogue document for providing to the server system a view termination signal for indicating a catalogue view termination when the client closes the text of the electronic catalogue document and the step of providing to the client administrator a fact that a particular client has terminated a view of particular display image along with an analytic evaluation result of observational behavior against goods image displayed on related display image when a view terminal signal for indicating catalogue view termination is provided.

18. A researching system for interests in commercial goods by using electronic catalogue including interactive 3D image data, the system comprising:
means for recording groups of images on a server, wherein each group of images having a multi-layered resolution and creating a 3d display effect when it is provided to a client, and the images each being constructed of a multiplicity of segmental images;
means for preparing electronic catalogue documents containing a display information relative to several groups of images to be provided with a lowest resolutions on initially being displayed, and display effect control tags against the groups of images such that an image insertedly displayed as part of contents of catalogue documents to raise a 3D display effect while the 3D display effect can be controlled by the client when the client having been accessed at a remote state can read the catalogue document;
means for providing a state where the prepared electronic catalogue document can be read by the client;
means for collecting, classifying and recording a display control signal when the client reads the electronic catalogue documents and transmits the display control signal for controlling display effect against the groups of images for being insertedly displayed on the electronic catalogue documents and producing enlargement/reduction display effect; and
means for analytically evaluating observational behaviors relative to goods image displayed on related display screen, on the basis of records of the display control signal from the client who has read the electronic catalog documents.

19. The system as defined in claim 18, wherein the means for analytically evaluating further comprises a means for analyzing related display image and frequency and observation period for observing a particular domain or a particular position of display image, based on display control signal sent from server.

20. The system as defined in claim 18, wherein the means for preparing electronic catalogue documents prepares electronic catalogue documents for comprising at least one link data for indicating a connection between part of screen displaying the interactive 3D image and other documents, whereas the means for analytically evaluating further comprises a means for clicking a specific part of related display image to analyze frequency of calling other documents connected to the part thereof.

21. The system as defined in claim 19, wherein the means for preparing electronic catalogue documents prepares electronic catalogue documents for comprising at least one link data for indicating a connection between part of screen displaying the interactive 3D image and other documents, whereas the means for analytically evaluating further comprises a means for clicking a specific part of related display image to analyze frequency of calling other documents connected to the part thereof.
